(19) United States
(12) Patent Application Publication
(10) Pub. No.: US 2025/0061348 A1
(43) Pub. Date: Feb. 20, 2025

(54) HIERARCHICAL GRID BASED GEOSPATIAL KNOWLEDGE GRAPH AND ASSOCIATED OPERATIONS

(71) Applicant: Foursquare Labs, Inc., New York, NY (US)

(72) Inventors: Vikram K Gundeti, Bellevue, WA (US); Vinod Sharma, Menlo Park, CA (US)

(21) Appl. No.: 18/661,410

(22) Filed: May 10, 2024

Related U.S. Application Data
(60) Provisional application No. 63/465,622, filed on May 11, 2023.

(51) Int. Cl. G06N 5/02

(52) U.S. Cl. CPC G06N 5/02

(57) ABSTRACT

Systems and methods for generating a geospatial knowledge graph system that efficiently organizes, queries, and analyzes location-based information at various granularities are provided. In some aspects, the geospatial knowledge graph is operable to aggregate and relate heterogeneous data associated with points of interests, entities, people, etc. Temporal information can also be integrated into the geospatial knowledge graph to track changes in heterogeneous data over geospatial regions over time.

### BACKGROUND

Existing geospatial data solutions require extensive amount of time and computing power to clean and normalize data. Additionally, existing geospatial data solutions generally store data in silos across different organizations and applications. The siloed data used by existing systems cannot be efficiently merged and used across different applications.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a geospatial knowledge graph system that efficiently organizes, queries, and analyzes location-based information at various granularities, ranging from individual places to neighborhoods, cities, and beyond. The geospatial knowledge graph represents cells in a hierarchical grid system as nodes in a graph. These nodes are connected to other real-world entities including points of interest, people, and the movement of people across different locations. By including these additional entities as nodes, the geospatial knowledge graph provides a comprehensive and versatile framework for representing complex spatial interactions and dependencies.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary hierarchical grid system.

FIG. 2 depicts an exemplary user interface for an application with one or more event categories, event cards, and interactive elements, according to aspects described herein.

FIG. 3 depicts an exemplary data graph illustrating exemplary data types which may be associated with a node in a knowledge graph.

FIG. 4 depicts an exemplary method 400 for capturing a temporal dimension of a hierarchical grid system and an associated graph knowledge set.

FIG. 5 depicts an exemplary method for summarizing data in a geospatial knowledge graph.

FIG. 6 depicts an exemplary method for performing a rollup function using a geospatial knowledge graph.

FIG. 7 depicts an exemplary method 700 for performing a breakdown of data across nodes in a geospatial knowledge graph.

FIG. 8 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which form a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Aspects of the present disclosure relate to a geospatial knowledge graph system that efficiently organizes, queries, and analyzes location-based information at various granularities, ranging from individual places to neighborhoods, cities, and beyond. The geospatial knowledge graph represents cells in a hierarchical grid system as nodes in a graph. These nodes are connected to other real-world entities (also represented as nodes in the graph) including points of interest (POIs), people, and the movement of people across different locations. By including these additional entities as nodes, the geospatial knowledge graph provides a comprehensive and versatile framework for representing complex spatial interactions and dependencies.

For example, a distributed network of mobile devices may be used to collect data across areas of different granularities (e.g., venues, neighborhoods, cities, states, countries, etc.). The mobile devices may be any type of device comprising network capabilities, location services, movement sensors, etc. Exemplary devices include, but are not limited to, smartphones, GPS devices, smartwatches, automobiles, airplanes, trains, etc. In examples, users may opt to include their devices in said distributed network, for example, by downloading an application which connects the device to the network. Upon installing said application and receiving permission to collect data, an individual device in the network may utilize onboard sensors to collect information that can be used to by stop detection technology to determine whether the device stopped at a particular location, venue, POI, geographic region, etc. For example, sensor data in combination with location data, such as GPS, wireless network scan data, cellular data, etc., can be used to determine whether a device visited a particular location.

Aspects of the present disclosure provide an improved system for the acquisition, aggregation, storage, and analysis of geospatial data. In examples, geospatial data, or spatial data, represents features or objects on the Earth's surface (or other planetary body), including their locations, shapes, and attributes. In examples, the geospatial knowledge graph disclosed herein is operable to store any type of attributes associated with a feature or object, including, but not limited to physical feature data, temporal data, temporary attributes, etc. Furthermore, the disclosed geospatial knowledge graph can be leveraged across a number of different technical areas. For example, the geospatial knowledge graph can be used to precisely track weather attributes across regions to show accurate weather forecasts at different levels of granularity, provide venue recommendations for different geographic areas, improve navigation applications, improved tracking of deliveries, optimize transportation routes across supply chains, etc.

Existing geospatial data solutions require extensive amount of time and computing power to clean and normalize data. Additionally, existing geospatial data solutions generally store data in silos across different organizations and applications. The siloed data used by existing systems cannot be efficiently merged and used across different applications. As location data analysis requires highly specialized knowledge and skill sets, it is difficult to use the siloed data with different applications and across various different technologies. Because of this, it is often difficult to consume and visualize (e.g., generate user interfaces conveying geospatial data and associated attributes) across different applications, devices, and technologies. The geospatial knowledge graph disclosed herein addresses all these shortcoming, among other limitations of existing technology, to provide an efficient and effective system for aggregating, storing, and processing geospatial data and various disparate types of data associated with geospatial regions.

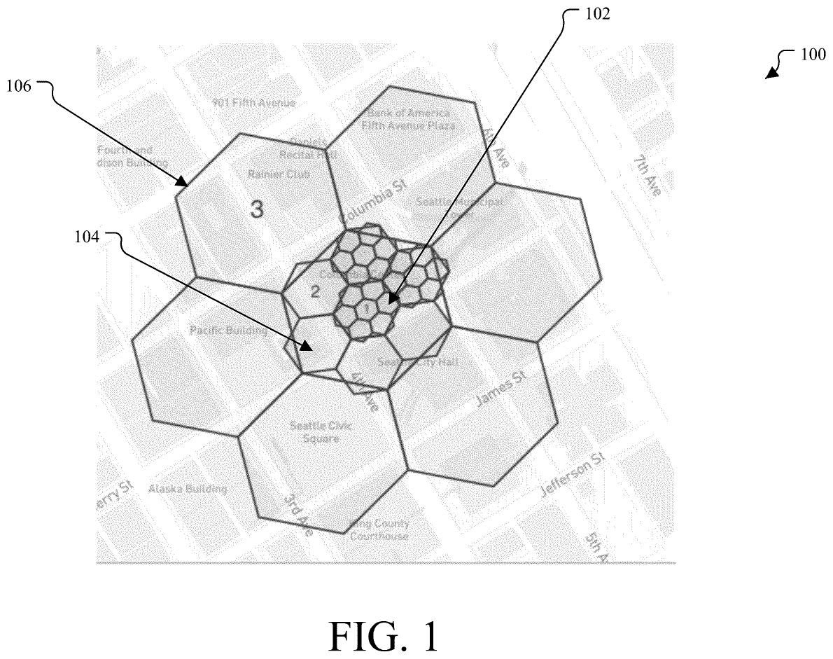

FIG. 1 depicts an exemplary hierarchical grid system 100. As shown in FIG. 1, the hierarchical grid system is operable to generate cells at different resolutions in order to represent a geographic area. As depicted in the hierarchical grid system 100, the cells are hexagonal, however, one of skill in the art will appreciate that different cell shapes can be employed by the various aspects disclosed herein without departing from the scope of this disclosure. The use of a hierarchical grid system provides a consistent and scalable solution for representing and managing large amounts of spatial data, which is a challenge faced by traditional geospatial systems.

As shown in FIG. 1, three different resolutions of cells are depicted. As used herein, the resolution of the cell may refer to the size of the geographic area represented by a particular cell. For example, a lower-level resolution cell may be used to store, depict, or represent information for a smaller geographic area. As the size of the geographic area increases, the resolution of the cell used to store, depict, or represent information for that geographic areas increases correspondingly. In examples, the larger resolution cells may include information for all of the lower resolution cells contained within the larger resolution cells. For example, hierarchical grid system 100 depicts three levels of resolution, level 1 resolution cells 102, depicting the smallest cells, level 2 resolution cells 104, representing the mid-level size of cells, and level 3 resolution cells 106, depicting the largest size of cells. While three levels of resolution are depicted in the hierarchical grid system 100, one of skill in the art will appreciate that fewer or greater number of resolutions may be employed by the aspects disclosed herein. For example, a lower level of resolution may represent a small geographic area, for example, one square meter on a map, while a higher level of resolution may represent a larger geographic area, up to and including, encompassing an entire global region.

As depicted in FIG. 1, the level 1 resolution cells 102 may be encompassed by a larger resolution cell. For example, as shown in the hierarchical grid system 100, seven level one cells 102 are encompassed in a single level two resolution cell 104. Similarly, approximately seven level 2 resolution cells 104 are encompassed in the larger level 3 resolution cell 106. While specific numbers of cells are shown as being encompassed by larger resolution cells in FIG. 1, one of skill in the art will appreciate that more or fewer lower resolution cells can be encompassed in a single cell of a higher resolution without departing from the scope of this disclosure.

Different entities and different information can be encompassed in a cell at a particular resolution, for example, at the lowest level resolution, e.g., resolution level 1 cell 102 shown in hierarchical grid system 100, various entities, such as, for example, venues, points of interest, people currently located in the cell, can be associated with a particular cell having resolution level 1 102. As resolution is increased, the data from all or a subset, depending on the type of data or type of query employed along with the hierarchical grid system 100, can be aggregated into the larger resolution cell. For example, all of the data or information (e.g., people, POIs, venues) of level 1 cells 102 can be aggregated into a level 2 cell 104. In examples, the subset may be determined based upon a type of application requesting data from the hierarchical grid system. For example, a navigation system may only select a subset of data comprising traffic data from when aggregating resolution cells, a venue system may select a subset of data comprising venue data, a weather application may only select a subset of data comprising weather information, etc.

While aspects of the present disclosure have thus far been described as creating and using a hierarchical grid system, such as hierarchical grid system 100, the data or information associated with the different cells in a hierarchical grid system can be stored and operated upon using a geospatial knowledge graph. A geospatial knowledge graph may be employed to not only represents locations (e.g., cells in a hierarchical graph) but also incorporate other real-world entities such as people, points of interest (POIs), events and transactions. By including these additional entities as nodes and explicitly modeling their relationships as edges in a graph, the geospatial knowledge graph provides a comprehensive and versatile framework for representing complex spatial interactions and dependencies. Use of a geospatial graph provides a richer expression of the spatial dependencies and interactions between different entities, allowing for advanced querying and analysis that would be difficult to achieve in more traditional geospatial systems.

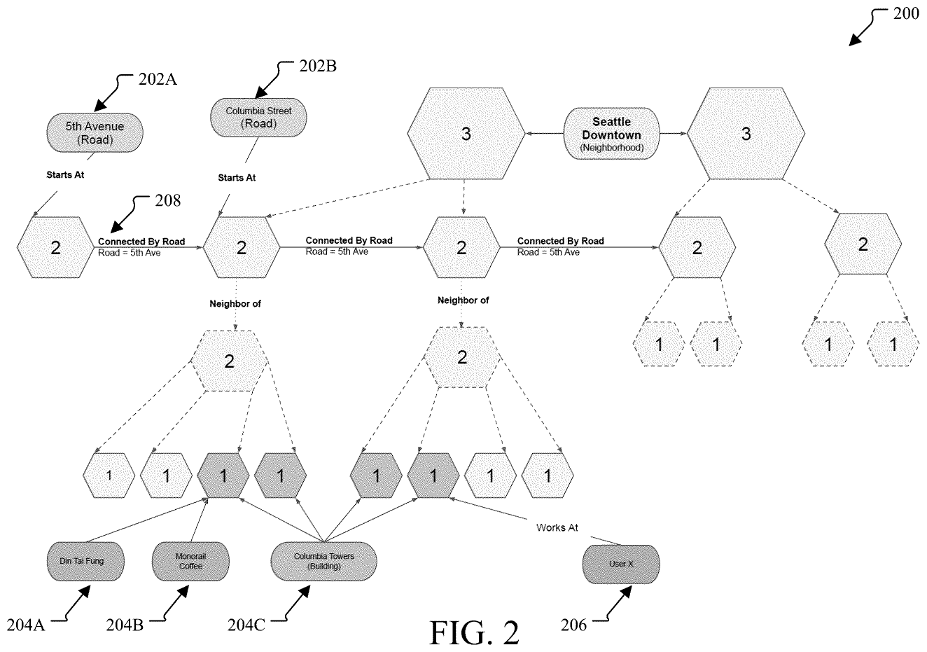

FIG. 2 depicts an exemplary geospatial knowledge graph 200 which is generated for a hierarchical grid system. For example, the hierarchical grid system 100 depicted in FIG. 1 depicts a hierarchical grid having three different resolutions representing a portion of downtown Seattle. The geospatial knowledge graph 200 depicts a graph representing the different cells on the grid, as well as the different entities (e.g., people, POIs, venues, etc.) that are associated with the cells in the graph. As shown in geospatial knowledge graph 200, exemplary POIs, such as different roads 202A-B (e.g., 5^{th} Avenue, Columbia Street), venues 204A-C (e.g., Columbia Towers, Monorail Coffee, Din Tai Fung) and people 206 (e.g., User x) may be included as nodes on the graph and related to various grid cells via relationships defined by the edges in the graph. Further, the different cells can be related through relational edges as well, for example as being part of the same neighborhood, as being connected by similar POIs 208 (e.g., connected by 5^{th} Avenue), etc. As such, any number of different relationships can be captured and used to interrelated different nodes on the graph (e.g., grid cells, POIs, users, venues, etc.). As such, various different types of data can be capture as nodes in the geospatial knowledge graph 200. Further, the relationships between the different types of data can be inferred or directly captured to generate edges between the nodes in the geospatial knowledge graph 202. Various different artificial intelligence or machine learning systems can be employed to capture node data and/or infer the relationship (i.e., edges) between the nodes, thereby allowing for the creation of a robust geospatial data system capable of capturing and interrelating disparate data from various different systems in a single, unified system.

The use of a geospatial knowledge graph 200 allows for the use to efficiently organize, aggregate, and perform operations on data associated with a geospatial app, as will be described further herein. Additionally, the use of the geospatial knowledge graph 200 allows for the efficient loading of data when users traverse a map, for example, when panning through adjacent cells in a similar level of resolution or zooming in or out on a map to load data from cells in different resolutions.

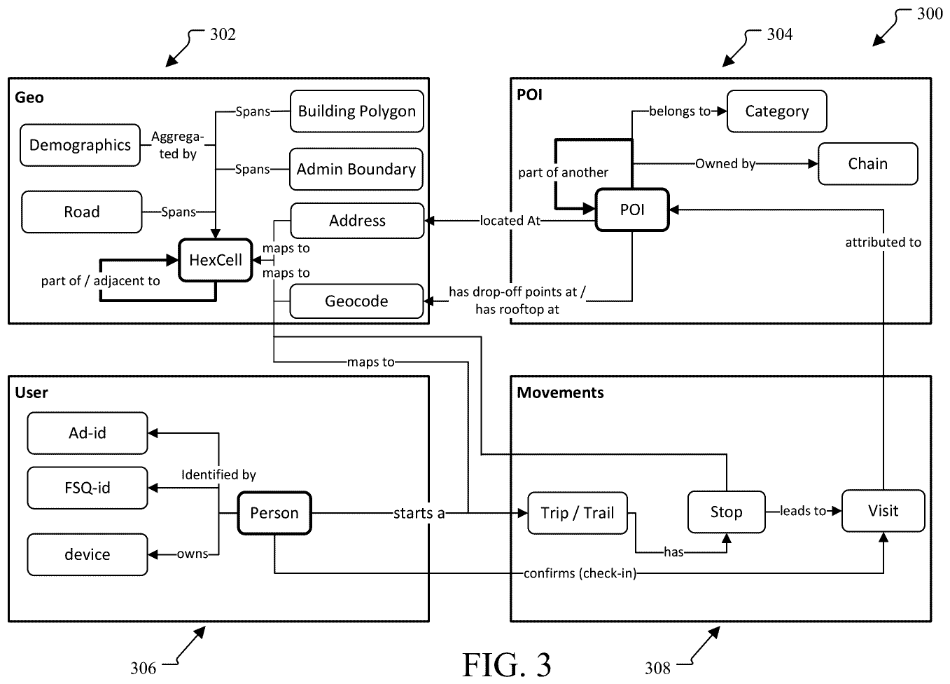

In further aspects, the different nodes in the geospatial knowledge graph 200 can include different types of information, based upon the type of entity being represented a particular node. As an example, FIG. 3 depicts an exemplary data graph 300 illustrating exemplary data types which may be associated with a node in a knowledge graph and by relationships between the different nodes. As shown in FIG. 3, various different entities can be stored, such as a geographic area 302, a POI 304, or a person/user 306. For example, a geographic area can include information such as different buildings in the area, the area's population demographics (or other geographic features of the area), roads within the geographic area, the cell associated with the geographic area on the map, addresses or geocodes encompassed in the area, etc. POIs may be associated with information such as other POIs associated with the particular POI, category classification information, chain information, etc. A person may be associated with information such as a person identifier, account identifier, device associated with the person, advertisements viewed by the person, etc. Further, the data graph 300 can be used to store and interrelate other types of data, such as actions associated with the different entities. One such example depicted in FIG. 3 is the movement data 308 associated with of user's device, which can be used to track a person as they visit different POIs, entities, or cells on the hierarchical grid.

The geospatial knowledge graph approach is inherently more flexible when it comes to integrating data from multiple sources, as it can easily accommodate different types of spatial entities and relationships. This is made possible by two factors: 1) Any spatial dataset can be indexed based on the identities of the cells, and 2) information associated with POI or entity, such as transactions or events can be efficiently incorporated as nodes in the knowledge graph. This is an advantage when working with heterogeneous datasets or collaborating across different domains.

As previously discussed, among other benefits, the graph-based structure of the geospatial knowledge graph lends itself to advanced graph analytics techniques that can uncover hidden patterns, clusters, and relationships in the data. These techniques can be more efficient and powerful than traditional geospatial analysis methods. Because heterogeneous data and data types are stored in the graph-based structure, the data can be consumed and processed using various different applications, algorithms, and machine learning models to identify patters and hidden relationships across disparate data. As such, the disclosed geospatial system addresses the deficiencies of existing, siloed, systems and provides unified geospatial system that can be utilized across various different types of applications and technology areas.

While aspects of the disclosure have thus far related to using cell based hierarchical grid systems in association with geospatial knowledge graphs, aspects of the present disclosure can further accommodate temporal data, thereby tracking changes in geographic characteristics, people, actions, entities, etc., over time. For example, a temporal dimension can be introduced to the geospatial knowledge graph system to build upon the foundation of the geospatial knowledge graph by incorporating a time dimension. Among other benefits, the introduction of a temporal dimension allows for improved analysis and understanding of location-based data over time. By taking snapshots of specific entities at regular time intervals, this approach facilitates as-of analysis and longitudinal analysis, allowing users to comprehend changes over a period of time and analyze temporal patterns in spatial data. The time-aware geospatial knowledge graph may continue to employ a hierarchical grid-based framework, as depicted in FIG. 1, to represent spatial entities as nodes in the graph. These nodes encompass a wide range of entities, such as grid cells, people, points of interest (POIs), and events at POIs, while accounting for their temporal dynamics.

The graph-based representation along with a temporal dimension enable understanding of not only how a specific entity has changed over time, but also help gain insights around how other entities have influenced change in an analyzed entity. The graph-based representation coupled with the temporal dimension can show, for example, changes in demographics of the neighborhoods served by that store was the driving factor in the increase/decrease of foot traffic, changes in traffic patterns, changes in weather patterns over different periods of time, etc.

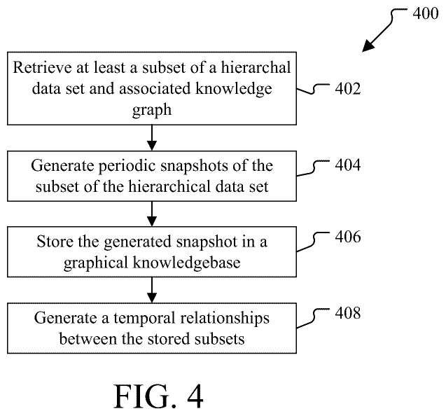

FIG. 4 depicts an exemplary method 400 for capturing a temporal dimension of a hierarchical grid system and an associated graph knowledge set. Flow begins at operation 402, where at least a subset of a hierarchical data set is retrieved. For example, a specific cell, a specific resolution of cells, or a specific set of cells on a map may be identified for a snapshot. The retrieval may be based upon a particular focus of analysis. For example, if the focus is to track development of a city over time, then the hierarchical cells, and their associated portions of a knowledge graph, may be retrieved at operation 402. Alternatively, or additionally, if demographic changes across large cities is to a focus of analysis, the hierarchical cells, and their associated portions of a knowledge graph, related to the cities being tracked may be retrieved at operation 402. Of note, the retrieval of cells for the snapshot need not be related geographically. That is, non-adjacent cells may be identified and retrieved at operation 402 based upon the focus of the analysis (e.g., demographic changes in different cities across the world). Further, only a subset of the associated knowledge graph may be retrieved at operation 402 based upon the analysis. Continuing with the demographic example, the data retrieved from the knowledge graph may be demographic data, while other data may be excluded at operation 402. This allows for the efficient retrieval of potentially very large data sets, as well as the creation of snapshots that may be smaller in size, thereby providing retrieval and storage efficiencies.

At operation 404, a snapshot is generated for the retrieved subset of hierarchical data and associated knowledge graph. For example, a copy of the retrieved data may be created and stored along with a temporal indicator indicating a time for the captured data. Flow continues to operation 406, wherein the copy of information is stored in the knowledge graph as a node in the graph. For example, the snapshot may be stored as a temporal node which includes the copied information. At operation 408, the stored snapshot may be related to other temporal snapshots for the same subset of data, for example, through the generation of relationship edges between a series of temporal snapshots generated for the same subset of data. In doing so, the temporal data can be efficiently tracked and operated on via the knowledge graph.

One of skill in the art will appreciate that any number of subsets for any level of granularity of data may be generated and stored, thereby allowing for the tracking of changes across time for various different entities of data stored in the graph knowledgebase. For example, the level of granularity tracked temporally may be as small as a single entity (e.g., a venue or person). Further, the type of changes tracked temporally can be specified, stored, and later recalled or analyzed using aspects of the present disclosure, such as the change in a road layout over time, the changes of demographics of a neighborhood, gentrification changes, foot traffic for a store, person movement through a region, etc. In doing so, aspects of the present disclosure provide a highly efficient (e.g., from storage of data and loading of data) solution to track various levels of granularity over a temporal dimension.

The use of a hierarchical grid system, such as the exemplary systems disclosed herein, as the foundation for the geospatial knowledge graph provides a consistent and scalable method for representing and managing large amounts of spatial data, which can be challenging in traditional geospatial systems. This enables efficient storage and querying of location-based information at different granularities. Further, aspects disclosed herein provide for dynamically computing information that can be attached to location nodes in the geospatial knowledge graph based on information attached to other nodes. Exemplary types of dynamic computations include summarization functions, rollup functions, and breakdown functions.

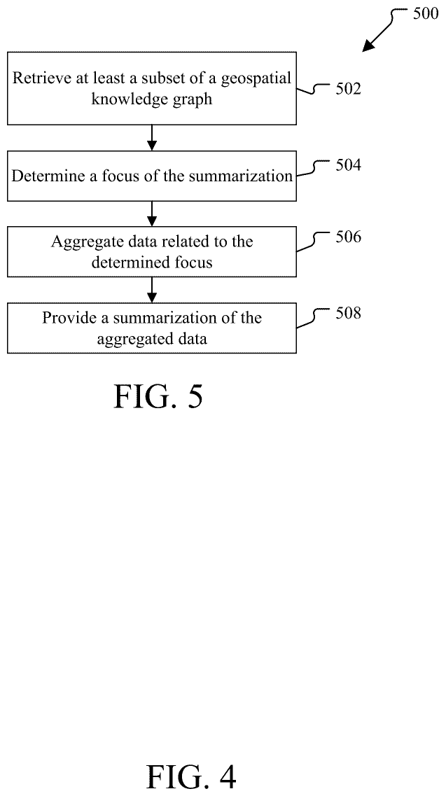

FIG. 5 depicts an exemplary method 500 for summarizing data in a geospatial knowledge graph. Flow begins at operation 508 where a subset of a geospatial knowledge graph is retrieved. The retrieved subset may be based upon the type of dynamic summarization that is to be performed. For example, the analysis may be related to computing the number of POIs or the density of POIs associated with one or more grid cells. At operation 502, the grid cells associated with the function are identified and their corresponding geospatial knowledge graph data is retrieved.

At operation 502, a focus of the summarization is determined. For example, the focus may be determined based upon the type of query or analysis received that initiated the summarization function. Continuing with the example noted above, the focus may be computing the number of POIs in the identified cells. The determined focus can be used to aggregate the information from the underlying geospatial knowledge graph at operation 506. For example, all of the POIs information of the associated cells can be aggregated, based upon the determined focus, and provided to a summarization function. The summarization function is executed on the aggregated data to provide a summarization. For example, continuing with the example above, the number of POIs may be determined by the aggregation function. Summarization functions, however, are not limited to mathematical functions. For example, the summarization function may relate to the generation of specific types of information about an entity or area, such as number of visitors associated with the entity or area, a description of various entities, etc. One of skill in the art will appreciate that any number of different summarization functions may be practiced with the aspects disclosed herein. At operation 508, the summarized information is provided, for example, for display on a user interface in response to a query, provided to another function for further analysis, or stored for later use.

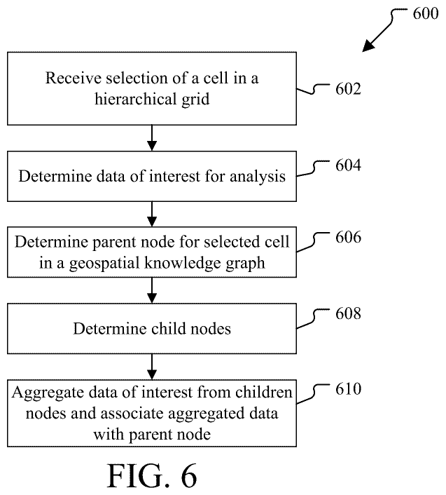

Another example of a dynamic function may be a rollup function. Rollup functions accept information tied to child nodes of a cell to compute a value that can be tied to the parent node of a cell. For instance, the number of POIs tied to a cell node at resolution 2, can be computed from the count of POIs tied to all the child cells (e.g., cells at resolution 1). FIG. 6 depicts an exemplary method 600 for performing a rollup function using a geospatial knowledge graph. Flow begins at operation 602, where a selection of a cell in a hierarchical grid is received. In one example, the selection may be received via a selection of a geographic region corresponding to a cell on a map. The selection may be received via a user interface displaying a map, or via a call to a specific region (e.g., via receipt of particular coordinates, a city name, etc.).

At operation 604, data of interest for the selected cell is determined. In one example, the data of interest may be determined based upon a specific query, such as the number of venues located within the cell, the number of points of interest, demographic information for the cell, traffic information for the cell, weather information, etc. Alternatively, or additionally, the data of interest may be inferred, for example, based upon the type of application selecting the cell, the user selecting the cell, etc.

Flow continues to operation 606, where the parent node associated with the selected cell is identified in an associated knowledge graph. Upon identifying the parent node, child nodes associated with the parent node are identified at operation 608. In one example, all child nodes associated with the parent node may be identified. Alternatively, in another example, only child nodes having the data of interest may be identified at operation 608. Upon identifying the child nodes, flow continues to operation 610 where the data of interest from, or associated with, the identified child nodes are aggregated and associated with the parent node, thereby rolling up the data of interest into the parent node. The aggregated data of interest may be stored with the parent node for future recall.

Yet another exemplary dynamic function that can be employed using the geospatial knowledge graph may be a breakdown function. Breakdown functions use data attached to a specific cell and its child cells to distribute a value tied to the parent cell to each of its child cells. A breakdown could be as simple as disaggregating the population information captured at a selected resolution cell to lower resolution cells by using uniform distribution or using other information tied to cells at the selected resolution such as whether there is a road, building or railway track contained within that cell to do a heuristic-based distribution.

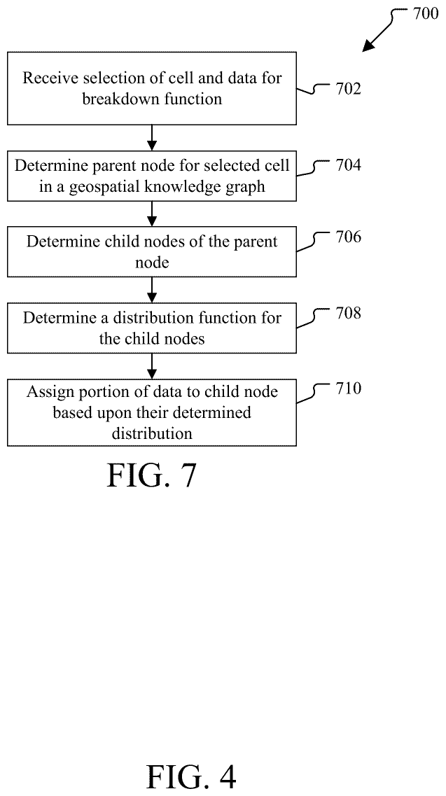

FIG. 7 depicts an exemplary method 700 for performing a breakdown of data across nodes in a geospatial knowledge graph. Flow begins at operation 702 where a selection of a cell selection of a cell in a hierarchical grid is received. In one example, the selection may be received via a selection of a geographic region corresponding to a cell on a map. The selection may be received via a user interface displaying a map, or via a call to a specific region (e.g., via receipt of particular coordinates, a city name, etc.). Further, the data identified for breakdown can be received at operation 702. Flow continues to operation 704, where the parent node associated with the selected cell is identified in an associated knowledge graph. Upon identifying the parent node, child nodes associated with the parent node are identified at operation 706. In one example, all child nodes associated with the parent node may be identified. Alternatively, in another example, only child nodes having the data of interest may be identified at operation 706.

At operation 708, a distribution is determined for the one or more child nodes. The distribution may be a weighted factor which identifies how much up the data from the parent node should be attributed to a particular child node. In many instances, it will not make sense to evenly divide the data between child nodes. For example, when dividing up the total population, a child node that includes a number of apartment buildings should be distributed a higher number of people than a node that covers a field. As such, at operation 708, a weighing factor may be determined for a particular child node based upon the type of data being distributed and the characteristics of the particular child node.

At operation 710, an amount of the data being broken down is assigned to the various child nodes based upon the weights associated with the child nodes. The breakdown data may be associated with the child node for future recall.

Additional aspects disclosed herein enable the derivation of insights at different location granularities, including at the Place, Neighborhood, mall/megaplex, and airport levels. At the Place level, the system allows for the understanding of the demographics of the visitors of the Place. At the Neighborhood level, the system allows for the understanding of the popular places visited by the people living in that Neighborhood. At the mall/megaplex level, the system allows for the understanding of the busy hours, the composition of the stores within that mall, and the locations within the mall where people are spending most of their time. At the airport level, the system allows for the understanding of the ingress/egress points of the airport, the busy hours, and the congested points within the airport at different times of the day. This system provides a powerful tool for analyzing and understanding spatial data, enabling users to gain insights into the movements and behaviors of people in the real world.

Further aspects allow for the derivation of insights about locations on different time scales. This system represents a hexagonal grid system as a hierarchical spatial graph and represents the real-world movements of users across places as a data graph. By overlaying the data graph on the hexagonal spatial graph, this system allows for efficient querying and analysis of spatial data at different levels of granularity and on different time scales. For example, the system can provide insights into the busy hours of a Place within a day, the busy days within a week, and the seasonal patterns within a year. Additionally, the system can provide insights into the travel patterns of people living within a specific neighborhood on a weekly basis, as well as the migration patterns of people across cities or states.

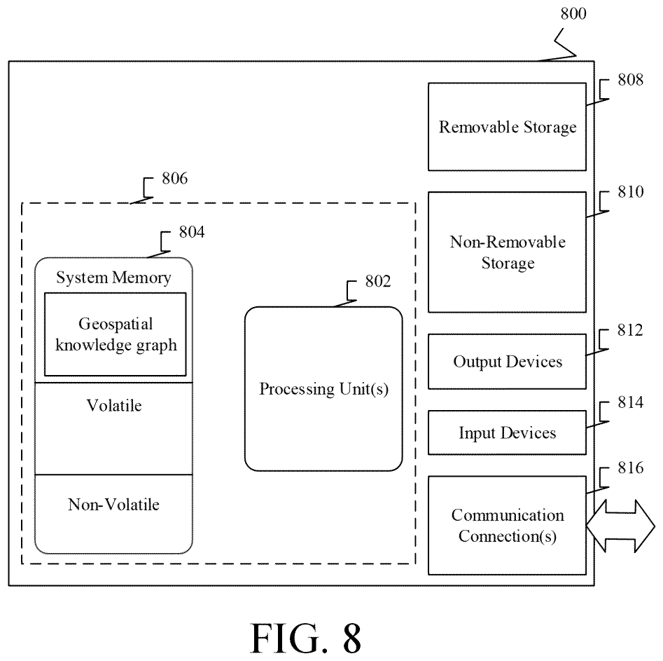

FIG. 8 illustrates a simplified block diagram of a device with which aspects of the present disclosure may be practiced, according to aspects described herein. The device may be a mobile computing device, for example. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, wearable devices such as smartwatches, virtual reality devices, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 (instructions to perform the aspects disclosed herein) may be volatile (such as RAM), non-volatile (such as ROM, flash memory, etc.), or some combination of the two. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as remote controller, keyboard, mouse, pen, voice input, on-board sensors, etc. and/or output device(s) 812 such as a display, speakers, printer, motors, etc. Also included in the environment may be one or more communication connections, 816, such as LAN, WAN, a near-field communications network, a cellular broadband network, point to point, etc.

Operating environment 800 typically includes at least some form of computer readable media. Computer readable media can be any available media that can be accessed by the at least one processing unit 802 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additional aspects of the present disclosure are provided in the accompanying Appendix.

What is claimed is:

1. A method comprising:
dividing a geographical area into a plurality of cells;
generating a plurality of nodes on a geospatial knowledge graph, wherein the plurality of nodes correspond to the plurality of cells;
generating relationships for the plurality of nodes, wherein spatial relationships are represented as edges between the plurality of nodes in the geospatial knowledge graph; and
generating relationships for the plurality of nodes, wherein the temporal relationships are relationships represented as properties of the geospatial knowledge graph.

2. The method of claim 1, further comprising generating a snapshot of at least a subset of the geospatial knowledge graph.

3. The method of claim 1, further comprising performing a summarization function using a subset of nodes from the geospatial knowledge graph.

4. The method of claim 1, further comprising performing a rollup function using a subset of nodes from the geospatial knowledge graph.

5. The method of claim 1, further comprising performing a breakdown function using a subset of nodes from the geospatial knowledge graph.

6. The method of claim 1, further comprising generating a second set of relationships for the plurality of nodes, wherein the second set of relationships comprises inferred relationships.

7. A system for generating and utilizing a geospatial knowledge graph, the system comprising:
at least one processor; and
memory storing instructions that, when executed by the at least one processor, causes the system to perform a set of operations, the set of operations comprising:
dividing a geographical area into a plurality of cells;
generating a plurality of nodes on a geospatial knowledge graph, wherein the plurality of nodes correspond to the plurality of cells;
generating relationships for the plurality of nodes, wherein spatial relationships are represented as edges between the plurality of nodes in the geospatial knowledge graph; and
generating relationships for the plurality of nodes, wherein the temporal relationships are relationships represented as properties of the geospatial knowledge graph.

8. The system of claim 7, wherein the set of operations further comprises generating a snapshot of at least a subset of the geospatial knowledge graph.

9. The system of claim 7, wherein the set of operations further comprises performing a summarization function using a subset of nodes from the geospatial knowledge graph.

10. The system of claim 7, wherein the set of operations further comprises performing a rollup function using a subset of nodes from the geospatial knowledge graph.

11. The system of claim 10, wherein the rollup function comprises:
receiving a selection of a cell;
determining a subset of data associated with the cell;
determine a parent node for the cell;
determine two or more child nodes of the cell; and
aggregating the subset of data from the two or more child nodes into the parent node.

12. The system of claim 7, further comprising performing a breakdown function using a subset of nodes from the geospatial knowledge graph.

13. The method of claim 1, further comprising generating a second set of relationships for the plurality of nodes, wherein the second set of relationships comprises inferred relationships.

14. A non-transitory computer storage medium comprising computer executable instructions that, when executed using one or more processors, performs a method comprising:
dividing a geographical area into a plurality of cells;
generating a plurality of nodes on a geospatial knowledge graph, wherein the plurality of nodes correspond to the plurality of cells;
generating relationships for the plurality of nodes, wherein spatial relationships are represented as edges between the plurality of nodes in the geospatial knowledge graph; and
generating relationships for the plurality of nodes, wherein the temporal relationships are relationships represented as properties of the geospatial knowledge graph.

15. The non-transitory computer storage medium of claim 14, wherein the method further comprises generating a snapshot of at least a subset of the geospatial knowledge graph.

16. The non-transitory computer storage medium of claim 14, wherein the method further comprises performing a summarization function using a subset of nodes from the geospatial knowledge graph.

17. The non-transitory computer storage medium of claim 1, wherein the method further comprises performing a rollup function using a subset of nodes from the geospatial knowledge graph.

18. The non-transitory computer storage medium of claim 14, wherein the method further comprises performing a breakdown function using a subset of nodes from the geospatial knowledge graph.

19. The non-transitory computer storage medium of claim 18, wherein performing the breakdown function comprises:
determining a parent node for a selected cell;
determining two or more children nodes of the parent node; and
assigning a portion of data to a specific child node of the two or more children nodes based upon a distribution function.

20. The non-transitory computer storage medium of claim 14, wherein the method further comprises generating a second set of relationships for the plurality of nodes, wherein the second set of relationships comprises inferred relationships.
